(19) United States
(12) Patent Application Publication
(10) Pub. No.: US 2019/0045969 A1
(43) Pub. Date: Feb. 14, 2019

(54) DRINKS PREPARATION MACHINE

(71) Applicant: Qbo Coffee GmbH, Wallisellen (CH)

(72) Inventor: Thomas Krewinkel, Plettenberg (DE)

(21) Appl. No.: 15/763,542

(22) PCT Filed: Oct. 5, 2016
(86) PCT No.: PCT/EP2016/073802

§ 371 Date: Mar. 27, 2018

(30) Foreign Application Priority Data
Oct. 20, 2015 (EP) 15190615.3

(51) Int. Cl. A47J 31/44; A47J 31/40; A47J 31/36

(52) U.S. Cl. CPC A47J 31/4428; A47J 31/3638; A47J 31/407

(57) ABSTRACT

A drinks preparation machine for preparing a drink from a portion capsule includes a brewing chamber for inserting the portion capsule, a drinks outlet, from which the drink which is brewed in the brewing chamber gets into a drinks vessel which is placed therebelow, a housing including a front portion that is given by the position of the drinks outlet, and a receiving module for receiving a fluid or a spent portion capsule. The receiving module can be pulled horizontally out of the front portion of the drinks preparation machine and pushed into this again, wherein a component of the drinks preparation machine forms an underlay and the receiving module is carried by the underlay on pulling out and pushing in. The drinks preparation machine includes a receiving module body and at least one slider that is fastenable to a lower side of the receiving module body and which on the underlay has a smaller coefficient of kinetic friction than the lower side of the receiving module body and a lower hardness than the surface of the underlay.

### BACKGROUND OF THE INVENTION

### Field of the Invention

The invention concerns the field of appliances for preparing hot and/or cold drinks. It especially relates to a drinks preparation machine for preparing a drink from a portion capsule.

### Description of Related Art

Drinks preparation machines with a high degree of automisation, such as for example coffee machines that use a portion capsule and have various additional functions, such as the preparation of tea or the production of milk froth, include various components that need to be emptied, filled and cleaned by the user at regular intervals. Water containers, capture containers or drip trays or also milk tanks of integrated milk frothers are examples of such components.

It is known per se for such components to be able to be integrated into a housing in the manner of a drawer, the housing shielding further components of the drinks preparation machine such as feed conduits, brewing module, brewing chamber, mains part, control etc., to the outside.

EP 1 740 078 and EP 2 342 997, for example, show drinks preparation machines, concerning which the drip tray (also called residual fluid collection container or residual water tray) can be brought in a guided manner into different positions which differ in their relative position to the housing and to further components of the drinks preparation machine. In EP 2 342 997, the guided transition from one position of the drip tray into another is additionally assisted by an adjusting mechanism.

Space-saving, compact drinks preparation machines, whose compactness to the greater part is due to components that are movable relative to one another, have the disadvantage that the mutual contact surfaces of the components wear, which can lead to scratches and grooves, but also to a reduced user friendliness to the point of faulty positionings of the components and, by way of this, false alarms that are triggered by sensors. This in turn is tantamount to value degradation, particularly with high-quality drinks preparation machines and can result in an increased service effort.

These disadvantages become even more acute if the different components are not only movable relative to one another, but are also supported on one another during the movement and if the supporting component is thereby loaded, for example due to it being filled with a fluid or with spent portion capsules.

### SUMMARY OF THE INVENTION

It is here that the invention comes into its own. It is an object of the invention to provide a drinks preparation machine that overcomes the disadvantages of the state of the art. In particular, it is an object of the invention to provide a compact drinks preparation machine that includes components that are movable relative to one another and relative to the housing of the drinks preparation machine, wherein the drinks preparation machine has a user-friendly and low-wear movement of the components that is constant over and beyond its service life.

A drinks preparation machine of the type according to the invention is designed as a drinks preparation machine for preparing a drink, in particular a hot drink such as coffee or tea, from a portion capsule. The drinks preparation machine includes a brewing chamber, a drinks outlet, a housing as well as at least one receiving module.

The portion capsule is insertable into the brewing chamber and the brewing chamber is designed to brew a drink on the basis of the portion capsule and water that is led into the brewing chamber. The brewed drink via the drinks outlet gets into a drinks vessel, which is positioned below the drinks outlet. A drinks preparation machine of the type according to the invention moreover includes a housing which, when viewed externally, can be coarsely subdivided into the front portion, side portions, rear side, base and upper part as part-regions. Herein, the front portion is given by the position of the drinks outlet.

A drinks preparation machine of the type according to the invention further includes at least one receiving module that is designed in a manner so as to receive a fluid or a spent portion capsule in itself. The receiving module is further characterised in that it can be pulled out of the front portion of the drinks preparation machine and pushed back into the front portion, in a horizontal manner. Herein, the receiving module is carried by an underlay on pulling-out and pushing in, the underlay being formed by a component of the drinks preparation machine. This means that the user only needs to muster a force that is directed along the horizontal when pulling out and pushing in, whereas the weight of the receiving module and its contents are carried by the underlay.

Different components of the drinks preparation machine can form the underlay for different receiving modules. It is particularly the upper side of the component forming the underlay for a receiving module that is arranged at least partly above the component forming the underlay in the drinks preparation machine.

The receiving module includes a receiving module body and at least one slider that is fastenable to a lower side of the receiving module body, wherein the at least one slider on the underlay has a smaller coefficient of kinetic (sliding) friction than the lower side of the receiving module body and a lower hardness than the surface of the underlay. The former leads to the prevention of an unnecessary force effort on pulling out and pushing in and effects a uniform sliding of the receiving module without juddering. The latter prevents a scratching and wearing of the underlay.

Complementarily, the drinks preparation machine can include the following features individually or in combination:
The at least one slider is exchangeable in a simple manner, for example by way of this being able to be clipped onto the lower side of the receiving module or being able to be brought into a holder, from which it can be removed in a simple manner.
A milk frother that is positionable laterally of the drinks outlet and is carried by a placement surface, which is a part of the at least one drip grate.
Disregarding the projecting parts “drinks outlet” and “drip grate”, the drinks preparation machine can have a cuboid shape.
At least the surface of the drinks preparation machine, which is visible on operation, in particular the part-regions “front portion” and “side portions” can have a uniformly painted surface.

In an embodiment, the drinks preparation machine moreover includes a drip tray and a drip grate.

Fluid that exits from the drinks outlet collects in one of the at least one drip tray in the case of an absent drinks vessel or in the case of the drinks vessel being incorrectly positioned. Apart from the drink itself, it can herein also be a fluid that exits out of the drinks outlet, for example, in the course of a cleaning or rinsing. Whereas the base and the side walls of the at least one drip tray are manufactured in a water-impermeable manner, the upper side of each of the at least one drip tray, i.e. the side of the drip tray that is directed towards the drinks outlet includes the drip grate, which belongs to this drip tray. This grate terminates the drip tray towards the drinks outlet in a fluid-permeable manner and is sufficiently stable to carry the drinks vessel.

In an embodiment, the drinks preparation machine moreover includes a capture container, a water container as well as a cup stand, wherein at least one of these three components is designed as a receiving module of the previously described type. It is, of course, to be understood that further components of the drinks preparation machine such as, for example, a milk container belonging to a milk frother can also be designed as a receiving module.

In the case that several components of the drinks preparation machine are designed as a receiving module, then each autonomously can be pulled out of the front portion of the drinks preparation machine and pushed into it. In particular, each receiving module can be movable independently of the position of the other receiving module.

The capture container is open towards the brewing chamber and serves for receiving spent portion capsules that are ejected from the brewing chamber. Supplementarily, the capture container can be arranged below the brewing chamber, which permits a simple ejection of the spent portion capsules out of the brewing chamber into the capture container, which is open at the top.

In embodiments of the drinks preparation machine, in which the water container can be pushed into an in particular cuboid drinks preparation machine, this water container can assume two positions, specifically a first, pushed-in position, which the water container assumes on operation of the drinks preparation machine, and a second position, which, for example, projects beyond the cuboid shape of the drinks preparation machine and in which the water container has a freely accessible opening for refilling water.

In particular, the cup stand is applied when smaller drinks vessels, for example espresso cups are used and these can be brought closer to the drinks outlet. In particular, the cup stand is located below the drinks outlet and it carries the drinks vessel, into which the drink brewed in the brewing chamber is to be filled.

Supplementarily to the drip tray and the drip grate, which are applied with larger drinks vessels, the cup stand can include a cup stand drip tray and a cup stand drip grate, which is directed towards the drinks outlet and on which the drinks vessel can be placed. Herein, the cup stand drip grate can be designed as an underlay for a receiving module, for example in the case of a capture container, which is designed as a receiving module and which is arranged above the cup stand.

Supplementarily, at least the surfaces of each and every receiving module, which are visible in the inserted position, have a visual appearance that is in conformity with the appearance of the remaining visible surfaces of the front portion, of the side portions and of the upper part. This leads to a uniform appearance of the complete surface of the drinks preparation machine. In particular, these visible surfaces can be of a plastic material and include a metallic coating and/or be painted completely throughout.

The uniform appearance of the surface of the drinks preparation machine can be interrupted by a device for reading off the fluid level in the water container. This device includes a window that is incorporated in the middle of the front portion of the water container and that extends essentially over the complete height of the water container. This device further includes an illumination means that illuminates the water surface and leads to a visual effect that can be perceived through the window. This effect, possibly together with details on the filling level, which are arranged in the region of the window, can serve for estimating the water level in the water container.

An analogous device for reading off the fluid level can also be integrated into the milk container. The milk container can alternatively consist of a transparent material.

The further the receiving module projects out of the front portion of the drinks preparation machine, the greater it is carried by the underlay, at least in its front region, wherein the underlay is exposed and is therefore visible, given a completely inserted receiving module.

In an embodiment of the drinks preparation machine, this underlay, which is exposed given an inserted receiving module and which carries the receiving module when this is horizontally pulled out of and horizontally pushed into the front portion, is one of the at least one drip grate of the drinks preparation machine.

In an embodiment of the drinks preparation machine, the at least one drip grate is manufactured of an alloy, in particular of an alloy that is rich in zinc, for example of a Zamak alloy.

The receiving module is only in contact with the underlay that carries the receiving module via the at least one slider. At least the surface of the at least one slider consists of a polymer, in particular of a polymer that contains fluorine, in order to fulfil the demands concerning the coefficient of static friction and coefficient of kinetic friction as well as hardness.

At least the surface of the at least one slider can consist of a perfluoroalkoxy-polymer (PFA) or polytetraflourethylene (PTFE). Examples of PFAs that can be applied for the sliders are Teflon® PFA, Dyneon® or Hyflon®. Examples of PTFEs that which can be applied with regard to the sliders are Teflon® and Dyneon® PTFE.

Not only does the surface of the at least one slider consist of one of the mentioned substances, but often the complete slider is manufactured from these.

In an embodiment, the drinks preparation machine further includes a guide rail and a counter-rail to this guide rail. Herein, the guide rail is attached to the lower side of the receiving module. As an alternative, the receiving module and the guide rail can be manufactured of one piece.

The counter-rail to the guide rail is fixedly connected to the housing of the drinks preparation machine, preferably within the housing and is therefore not visible.

The at least one slider is attached to the guide rail and is fixedly connected to this. For example, the slider can be clipped or bonded onto the guide rail or connected in any other fixed manner, but preferably such that it can be reversibly removed again.

The guide rail and the counter-rail are designed such that the receiving module is laterally guided during the withdrawal and insertion.

Supplementarily, the receiving module can include several guide rails, on which one or more sliders are attached. Herein, the individual guide rails do not have to be equally long, but they can also be interrupted or arranged in a locally limited manner. Embodiments with several guide rails (and accordingly several counter-rails) lead to more stability during the pulling-out and pushing-in of the receiving module, so that a jamming is avoided. A multitude of guide rails is moreover advantageous in situations in which the receiving module must stand independently without further supports, for example during an emptying or cleaning or during a refilling.

Supplementarily, the at least one counter-rail and/or the at least one guide rail and/or the carrying underlay can be designed to the extent that certain positions of the receiving module, for example an operating position, a refilling position and/or a cleaning position are defined. Such positions can be defined, for example, by way of latching-in elements and/or thickenings, and recesses.

In an alternative embodiment of the drinks preparation machine, this can include one or more side walls and/or one or more intermediate walls.

A side wall is part of the housing, said housing terminating the drinks preparation machine to the outside, or is directly adjacent to this housing, whereas an intermediate wall is located within the drinks preparation machine in a manner spaced from the housing. In particular, the side walls and intermediate walls (hereinafter called walls) run in the vertical direction.

Two of these walls per receiving module are designed in a manner such that a lateral guidance of the receiving module takes place. For example, two side walls or two intermediate walls or a side wall and an intermediate wall ensure the lateral guidance of the receiving module. Herein, different receiving modules can be guided by the same two walls.

One can make do without the application of the guide rail and counter-rail to the guide rail in embodiments of the drinks preparation machine, in which side walls and/or intermediate walls ensure a lateral guidance of the receiving module. In the case that a drinks preparation machine includes several receiving modules that can be pulled horizontally out of the front portion of the drinks preparation machine and pushed into this again, one or more of these receiving modules can be laterally guided by one or more guide rails and counter-rails and one or more of these receiving modules can be laterally guided by side walls and intermediate walls.

The walls can include regions with horizontally running sections that improve the guidance of the receiving module. Supplementarily, these regions can be module-selective, i.e. they prevent an incorrect receiving module from being pushed in.

Furthermore, the walls can also include means for the definition of certain positions of the receiving module in the previously described way and manner.

In an embodiment of the drinks preparation machine, the receiving module includes a grip, via which the receiving module can be pulled out of the front portion of the drinks preparation machine in the horizontal direction. In particular, this grip can be designed as a recessed grip, which means that this grip has no region that projects beyond the housing of the drinks preparation machine. Receiving modules that are arranged next to one another or above one another can include recessed grips that are matched to one another.

In an embodiment of the drinks preparation machine, the slider and the underlay are selected such that the slider on the underlay has a coefficient of kinetic friction of smaller than 0.4, in particular smaller than 0.3 or smaller than 0.2, as well as a coefficient of static friction of smaller than 0.5, in particular smaller than 0.4 or smaller than 0.3.

Embodiment examples of the invention are hereinafter described by way of figures. In the figures, the same reference numerals indicate the same or analogous elements. There are shown in:

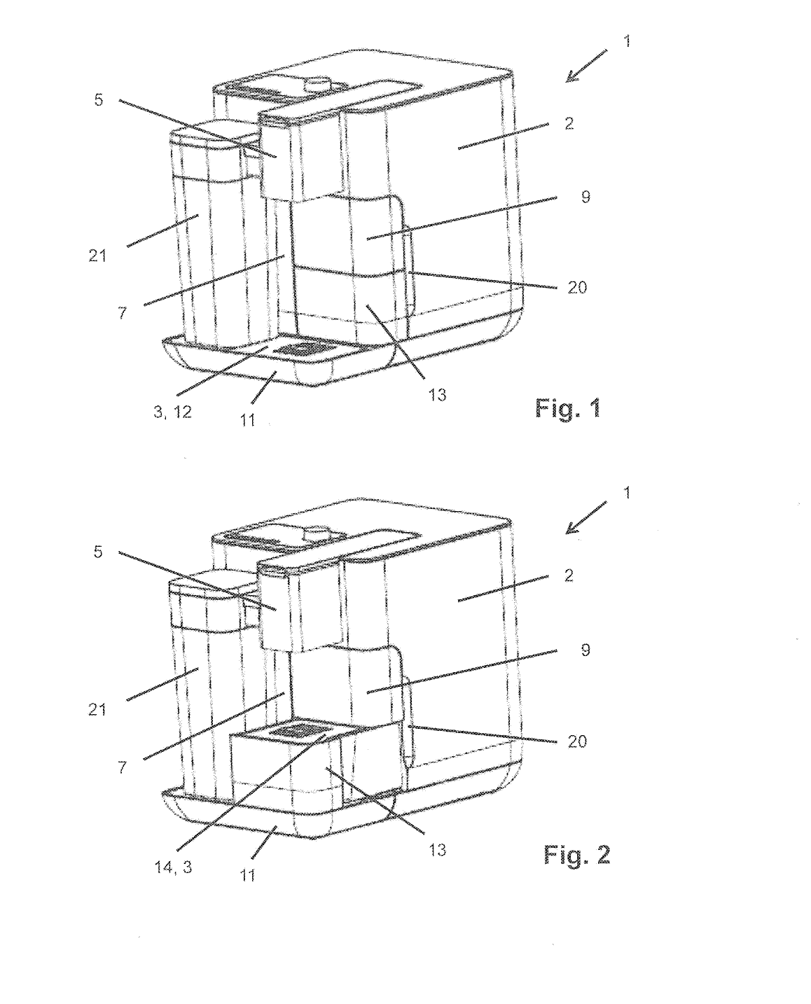

FIG. 1 is a view of a drinks preparation machine that includes several receiving modules;

FIG. 2 is a view of the drinks preparation machine with a pulled-out cup stand, which is designed as a receiving module;

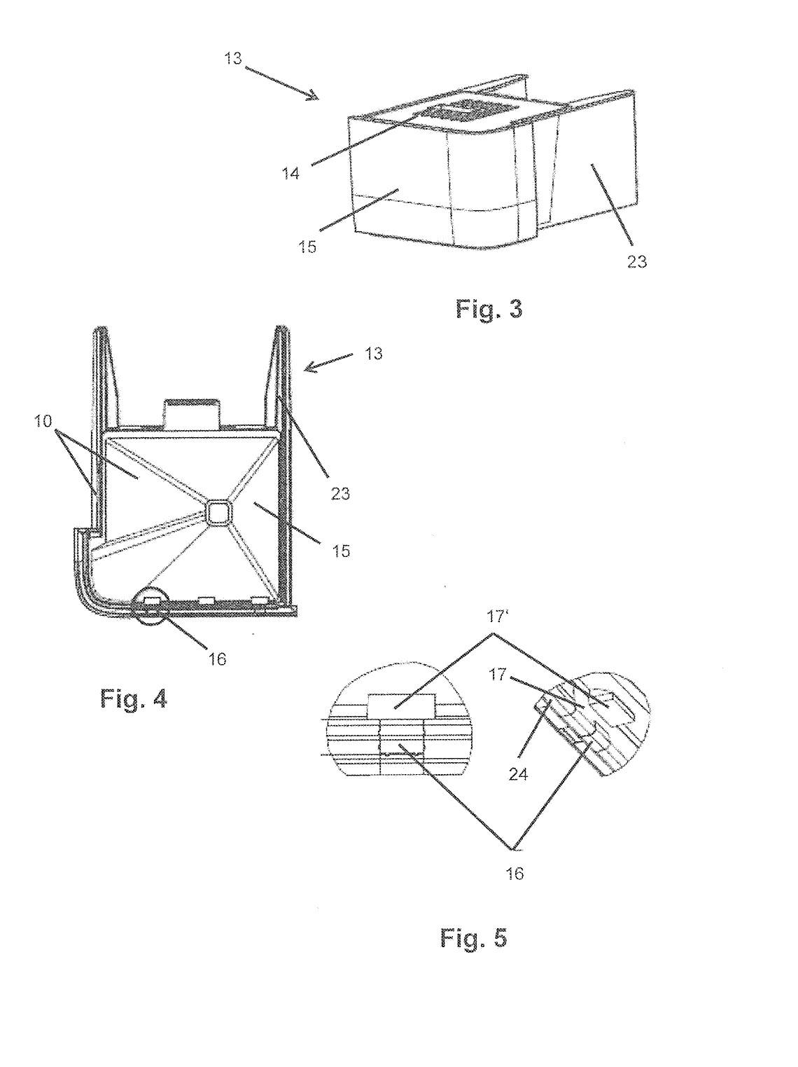

FIG. 3 is a view of the cup stand;

FIG. 4 is a view of the underside of the cup stand including several sliders;

FIG. 5 is a detailed view of the sliders that are used with the cup stand;

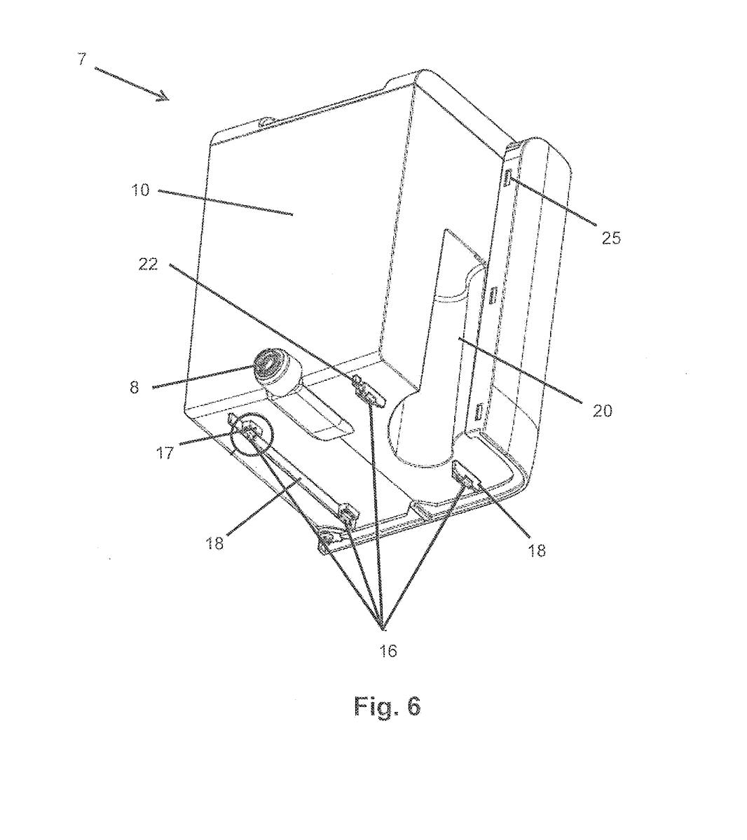

FIG. 6 is a view of a water container that is designed as a receiving module;

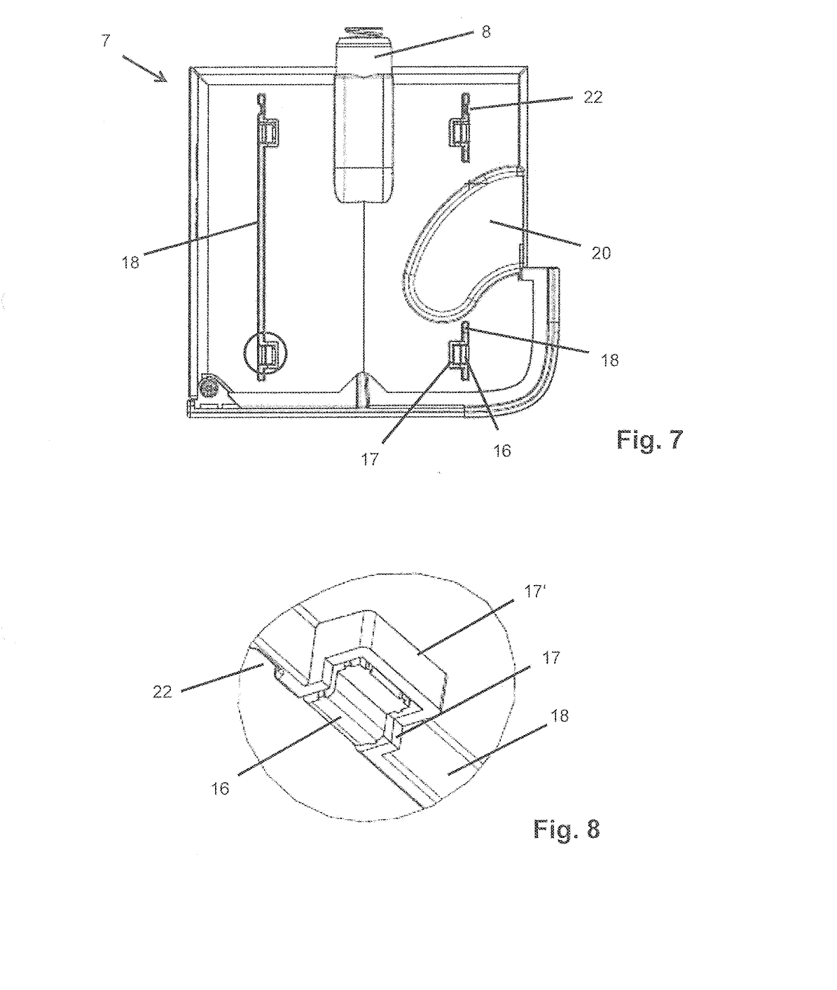

FIG. 7 is a view of the lower side of the water container including several sliders; and

FIG. 8 is a detailed view of the sliders that are used with the water container.

### DETAILED DESCRIPTION OF THE INVENTION

The drinks preparation machine 1 according to FIG. 1 for example is a portion capsule coffee machine of the type known per se, with a horizontal brewing module. Apart from a housing 2, it includes a placement surface 3, which in the shown embodiment is a part-region of a drip grate 12, a drip tray 11, a drinks outlet 5 and optionally a milk frother 21. The drinks preparation machine 1 further includes a water container 7 (in the shown embodiment partly covered by the milk frother 21), a capture container 9 as well as a cup stand 13. Due to the shape of the drinks preparation machine 1, this can be coarsely subdivided into the regions front portion, side portions, rear side, base and upper part. Thereby, the front portion is that region of the drinks preparation machine 1 which faces the user on operation, i.e. as a rule it includes the drinks outlet 5.

In the shown embodiment, the water container 7, the capture container 9 and also the cup stand 13 are receiving modules in the previously described context. In particular, the water container 7, capture container 9 and cup stand 13 each include a receiving module body 10 and one or more sliders 16.

In particular, the water container 7, the capture container 9 as well as the cup stand 13 can be pushed into the housing 2 such that their surface parts, which in the pushed-in condition form parts of the surface of the front portion and of the side portions, run flush with these. The drinks preparation machine 1 obtains an essentially cuboid shape by way of this. It is only the drinks outlet 1, the drip tray 11 with its upper-side termination by the drip grate 12 as well as the optionally attached, simply removable milk frother 21 that interrupt the cuboid shape of the drinks preparation machine 1.

The surface of the regions of these receiving modules, the regions lying to the outside in the inserted condition, are finished in the same manner as the remaining regions of the front portion and of the two side portions. For example, all these regions can be painted right the way through and/or be of a high-quality, in particular metallic material.

The surface of the drinks preparation machine 1, which is continuous in the inserted condition of the mentioned receiving modules, is only interrupted in the region of the side portions, at the contact lines between the receiving modules and the housing 2, by way of recessed grips 20 being incorporated there. These permit the separate withdrawal of each receiving module by the user.

FIG. 2 shows the drinks preparation machine 1 according to FIG. 1, wherein the cup stand 13 is pulled out as far as is necessary for its use on operation. On pulling out the cup stand 13, as well as when later pushing it in, it slides over the drip grate 12. This would lead to a visible wearing on the drip grate 12 in the absence of the measures that are shown in the FIGS. 4 and 5.

FIG. 3 shows a cup stand 13 that is completely pulled out of the drinks preparation machine 1. This cup stand includes a cup stand drip grate 14, as well as a cup stand drip tray 15, which is located therebelow. On the machine side, the cup stand 13 further includes continuations 23, which lead to a fixation of the position of the pulled-out cup stand 13.

The lower side of the cup stand 13 according to FIG. 3 is shown in FIG. 4. The receiving module body 10 of the cup stand 13 at its user-side end includes three sliders 16. Each of these sliders 16 is 5 mm long and about 2 mm wide in the shown embodiment. It is to be understood that other dimensions, in particular in the mm to cm range and in particular in the range between 1 mm and 5 cm also lead to good sliding behaviour and a stable footing of the receiving module on operation.

In the shown embodiment, the sliders 6 are manufactured from perfluoroalkoxy polymer (PFA). The cup stand 13 is carried by the drip grate 12 when it is pulled out and pushed in. The drip grate 12 thus forms a carrying underlay for the cup stand 13 in the previously described context. The drip grate 12 comes into contact exclusively with the sliders 16 on pulling out and pushing in the cup stand 13.

The drip grate 12 is manufactured from a Zamak alloy. PFA and Zamak alloy lead to a particularly advantageous, i.e. low coefficient of static friction and coefficient of kinetic friction. Moreover, the hardness of the Zamak alloy is greater than that of PFA, by which means a scratching of the drip grate is prevented.

FIG. 5 is a detailed view of a slider 16 according to FIG. 4. This slider is brought into a holder 17, which, for its part, is clipped onto a carrier 24, which is fixedly connected to the cup stand 13. The holder 17 further includes a stop 17′ that prevents the slider 16 from being brought out of its position, which is necessary for sliding on the drip grate 12.

The carrier 24, holder 17 and slider 16 are arranged below the cup stand 13 such that only a small, e.g. hardly visible gap arises between the cup stand 13 and the drip tray 11 or drip grate 12, particularly given a pushed-in cup stand 13.

It is of course to be naturally understood that other parts of the drinks preparation machine 1, in particular the capture container 9, can also be realised analogously. In the case of the capture container 9, this slides over the cup stand drip grate 14.

The disassembled water container 7 of the drinks preparation machine 1 according to FIG. 1, designed as a receiving module, is represented in FIGS. 6 and 7. FIG. 6 shows the rear side, the base as well as the side that coincides with the side portion of the housing 2 of the drinks preparation machine 1. FIG. 7 shows only the base of the water container 7.

The shown water container 7 includes a water outlet 8, which, on pushing in the water container 7, engages into a counter-piece, which is at the machine side, which is to say belongs to the machine. The receiving module body 10 of the water container 7 includes four sliders 16 on its lower side, in order to achieve the positional accuracy that is required for this, but also therewith to provide a water container 7, which is completely or partly pulled out of the housing 2 with a secure footing. These sliders are attached on guide rails 18 amid the use of holders 17, wherein the guide rail 18, which is situated towards the side portion of the housing 2, is interrupted by the recessed grip 20.

Counter-rails (not shown) to the guide rails, the counter-rails being attached on the machine side, ensure the necessary lateral guidance of the water container 7. These counter-rails are preferably located only on the base of the cavity in the drinks preparation machine 1, the cavity being envisaged for receiving the water container. These counter-rails are therefore not visible when the water container 7 is pushed in.

Positioning recesses 22 in combination with corresponding counter-pieces on the counter-rails ensure that the water container 7 assumes well-defined and stable positions for operation or for refilling. The latching of the counter-pieces into the positioning recess 22 moreover leads to an audible clicking and therefore to a signal to the user, the signal signalising that the water container 7 assumes a correct position.

The recessed grip 20 is dimensioned such that the fingers of the user find space here.

Further, the water container 7 at a surface that forms the termination or closure of that region of the surface of the water container 7, which is given a quality finish just as the front surfaces and side surfaces of the drinks preparation machine 1 includes means 25, in order to further stabilise the water container, which is possible heavy due to being full. Furthermore, these means 25 serve for providing the user with an acoustic and/or visual impression as to whether the water container has been correctly inserted. In the shown embodiment, these means 25 include latch-in recesses, into which corresponding elements that are attached at the housing-side latch.

Finally FIG. 8 shows the sliders 16, which are attached to the lower side of the water container according to FIGS. 6 and 7. Each slider 16 is held in position by the holder 17. In the shown embodiment, the slider 16 is clipped into the holder 17 or is bonded into the holder 17.

The holder 17 is fixedly connected to the guide rail 18 and includes a stop 17′, which runs in a flush manner with the base of the water container 7. This prevents a rotating-away of the holder and herewith prevents the water container 7 from not sliding or not exclusively sliding on the sliders 16.

In the shown embodiment, the sliders 16 have a length of 5 mm and a total width of 4 mm, wherein the effective running width is about 2 mm. Of course, it is to be understood that other dimensions, in particular lengths in the range of between 5 mm and 5 cm likewise achieve good result.

The sliders 16 in turn are manufactured from PFA.

In an arrangement of the water container 7 as is shown in FIG. 1, on pulling out and pushing in, it slides over a non-structured part-region of the previously described drip grate 12. Here, that which has been said in the description of FIG. 4 with regard to the coefficient of static friction and coefficient of kinetic friction as well as the scratching of the drip grate also applies here.

The lateral guidance of the movement of the receiving modules, which are shown in FIGS. 1-8, can be effected on the part of the machine in two manners: on the one hand via the counter-rails, which are mentioned above and which are fastened to the housing 2, and on the other hand, via a vertical intermediate wall, which is attached in the interior of the housing 2.

A vertical intermediate wall (not shown), which runs between the water container 7 and the two mentioned receiving modules, together with the side wall of the housing 2, which lies close to these two receiving modules assumes the lateral guiding of the two receiving modules in the case of a capture container 9 and the cup stand 13.

The interior of the housing 2 moreover includes a horizontal intermediate wall (not shown), which is located between the capture container 9 and the cup stand 13. This forms the carrying underlay for those regions of the capture container 9 that are located within the housing 2. In the case of a completely pushed-in capture container 9, this is consequently fully carried by the horizontal intermediate wall and does not rest on the cup stand drip grate 14.

1. A drinks preparation machine for preparing a drink from a portion capsule, comprising:
a brewing chamber for inserting the portion capsule,
a drinks outlet, from which the drink which is brewed in the brewing chamber gets into a drinks vessel which is placed therebelow,
a housing comprising a front portion that is given by the position of the drinks outlet, as well as
a receiving module for receiving a fluid or a spent portion capsule, wherein the receiving module can be pulled out of the front portion of the drinks preparation machine and pushed into this again, in a horizontal manner, wherein a component of the drinks preparation machine forms an underlay and the receiving module is carried by the underlay on pulling out and pushing in,
wherein the receiving module comprises a receiving module body and at least one slider, which is fastenable to a lower side of the receiving module body and which on the underlay has a smaller coefficient of kinetic friction than the lower side of the receiving module body and a lower hardness than the surface of the underlay.

2. The drinks preparation machine according to claim 1, comprising at least one drip tray, in which fluid collects, said fluid exiting from the drinks outlet in the case of an absent or incorrectly positioned drinks vessel, and at least one drip grate which terminates the drip tray towards the drinks outlet in a fluid permeable manner and on which the drinks vessel can be placed, wherein the drip grate forms the underlay.

3. The drinks preparation machine according to claim 1, further comprising a
a capture container which is open towards the brewing chamber and which is designed for receiving spent portion capsules which are ejected out of the brewing chamber,
a water container, as well as
a cup stand comprising a cup stand drip tray and a cup stand drip grate, wherein the cup stand drip grate is designed so as to form the underlay,
wherein at least one of the components capture container, water container and cup stand is designed as a receiving module.

4. The drinks preparation machine according to claim 2, wherein the at least one drip grate is manufactured of an alloy, in particular of a zinc-containing alloy.

5. The drinks preparation machine according to claim 1, wherein at least the surface of the at least one slider consists of a polymer which contains fluorine.

6. The drinks preparation machine according to claim 5, wherein at least the surface of the at least one slider consists of a perfluoroalkoxy polymer (PFA) or polytetrafluorethylene (PTFE).

7. The drinks preparation machine according to claim 1, further comprising a guide rail and a counter-rail to the guide rail, wherein the guide rail is attached to the lower side of the receiving module and the at least one slider to the guide rail, and the counter-rail is fixedly connected to the housing of the drinks preparation machine and wherein the receiving module is movable in a laterally guided manner on account of the guide rail and counter-rail.

8. The drinks preparation machine according to claim 1, further comprising one or more side walls and/or one or more intermediate walls, wherein the receiving module is movable in a laterally guided manner between two side walls or between two intermediate walls or between a side wall and an intermediate wall.

9. The drinks preparation machine according to claim 1, wherein the receiving module has a grip, via which a horizontal force can be exerted onto the receiving module.

10. The drinks preparation machine according to claim 1, wherein the at least one slider on the underlay has a coefficient of kinetic friction of smaller than 0.4 and a coefficient of static friction of smaller than 0.5.
